(19) United States
(12) Patent Application Publication
(10) Pub. No.: US 2003/0021400 A1
(43) Pub. Date: Jan. 30, 2003

(54) Audio conferencing system and method

(76) Inventors: Charles M. Grandgent, Maynard, MA (US); Candace Deliman, Atlantic Highlands, NJ (US); Dean E. Harvey, Colts Neck, NJ (US); Brandon Jackson, Hudson, NH (US)

Correspondence Address: PENNIE AND EDMONDS, 1155 AVENUE OF THE AMERICAS, NEW YORK, NY, 100362711

(21) Appl. No.: 10/135,282

(22) Filed: Apr. 30, 2002

Related U.S. Application Data
(60) Provisional application No. 60/287,442, filed on Apr. 30, 2001.

(51) Int. Cl. H04M 3/42

(52) U.S. Cl. 379/202.01; 379/100.17; 709/204

(57) ABSTRACT

In a preferred embodiment, the system of the present invention comprises two or more bridge servers; one or more conferencing servers, each of which is configured to communicate with at least one of said bridge servers; and a transaction server, in communication with each conferencing server. The transaction server is configured to manage conferencing resources among the conferencing servers. Each conferencing server is preferably configured to monitor bridge status for each bridge assigned to it and to provide bridge status information to the transaction server. The transaction server and conferencing servers are preferably further configured such that bridge servers assigned to a first conferencing server are subsequently assigned to a second conferencing server by the transaction server if the first conferencing server fails.

### CROSS-REFERENCE TO RELATED APPLICATIONS

This application claims priority to U.S. Provisional Application No. 60/287,442, filed Apr. 30, 2001, the entire contents of which are incorporated herein by reference.

### FIELD OF THE INVENTION

The present invention relates to the field of audio conferencing systems, and in particular to a multiple bridge server based audio conferencing system and method.

### BACKGROUND

Telephone conferencing systems are known. However, such systems typically comprise a single bridge server and, even when comprising multiple bridge servers, typically do not provide mechanisms for providing continuous service in the event of a server failure. There is thus a need for a system and method that provides continuous, reliable audio conferencing services.

### SUMMARY

It is an object of the present invention to provide an audio conferencing system and method comprising more than one bridge server that provides continuous, reliable services.

In a preferred embodiment, the system of the present invention comprises two or more bridge servers; one or more conferencing servers, each of which is configured to communicate with at least one of said bridge servers; and a transaction server, in communication with each conferencing server. The transaction server is configured to manage conferencing resources among the conferencing servers.

The preferred embodiment further comprises one or more SS7 servers and one or more Web servers in communication with the transaction server. Each SS7 server is preferably configured to receive data from wireless or wireline service providers, and each Web server is preferably configured to dynamically generate wireless mark up language that can be communicated to wireless devices.

Preferably, the transaction server is configured to process incoming messages using a thread pool, to assign each conferencing server a list of bridge servers to control, and to perform load balancing among conferencing and bridge servers. Each conferencing server is preferably configured to monitor bridge status for each bridge assigned to it and to provide bridge status information to the transaction server. The transaction server and conferencing servers are preferably further configured such that bridge servers assigned to a first conferencing server are subsequently assigned to a second conferencing server by the transaction server if the first conferencing server fails.

Also in the preferred embodiment, at least one Web server is configured to communicate over a computer network with a wireless device configured to display a graphical user interface in accordance with data received from the Web server.

It is also an object of the present invention to provide voice recognition capabilities and advantages to a conferencing system.

### BRIEF DESCRIPTION OF THE DRAWINGS

FIG. 1 depicts a preferred conferencing system 10.

FIG. 2 depicts a preferred conferencing server 20.

FIG. 3 shows a preferred user login screen.

FIG. 4 shows a preferred user configuration screen.

FIG. 5 shows a screen that includes a phone number field and password field.

FIG. 6 shows a user welcome screen.

FIG. 7 shows a user welcome screen wherein a user has selected a set-up conference call feature.

FIG. 8 shows a screen wherein a user has elected to create a new team list.

FIG. 9 shows a screen comprising various fields for creating a team list.

FIG. 10 shows a screen with team list information filled in.

FIG. 11 shows a screen wherein a user may choose to conference now or schedule a conference for later.

FIG. 12 shows a screen enabling a user to select which team members are to participate in a conference, and how they are to be contacted.

FIG. 13 shows a screen notifying a user that the user's team is being called.

FIG. 14 shows a screen enabling a user to enter conference scheduling information.

FIG. 15 shows a screen enabling a user to select a conference team to have an alert sent to.

FIG. 16 shows a screen enabling a user to enter an alert message.

FIG. 17 shows an Information and Help screen.

FIG. 18 shows a log off screen.

FIG. 19 depicts a cell phone screen for first time registration.

FIG. 20 depicts a cell phone screen wherein a user has entered a cell phone number.

FIG. 21 depicts a cell phone screen wherein a user has entered a password.

FIG. 22 depicts a cell phone screen displaying a user's team for conferencing.

FIG. 23 depicts a cell phone screen displaying a team list.

FIG. 24 depicts a cell phone screen wherein a user has selected conference participants from a team list.

FIG. 25 depicts a cell phone screen enabling a user to add a number, conference now, or schedule a conference for later.

FIG. 26 depicts a cell phone screen notifying a user who has elected to conference now that the user's selected team members are being called.

FIG. 27 depicts a cell phone screen enabling a user to schedule a conference call.

FIG. 28 depicts a cell phone screen after a user has entered scheduling information.

FIG. 29 depicts a cell phone screen notifying a user that the selected team has been notified of a scheduled conference.

FIG. 30 is a call flow diagram with member selection.

FIG. 31 is a call flow diagram without member selection.

### DETAILED DESCRIPTION OF PREFERRED EMBODIMENTS

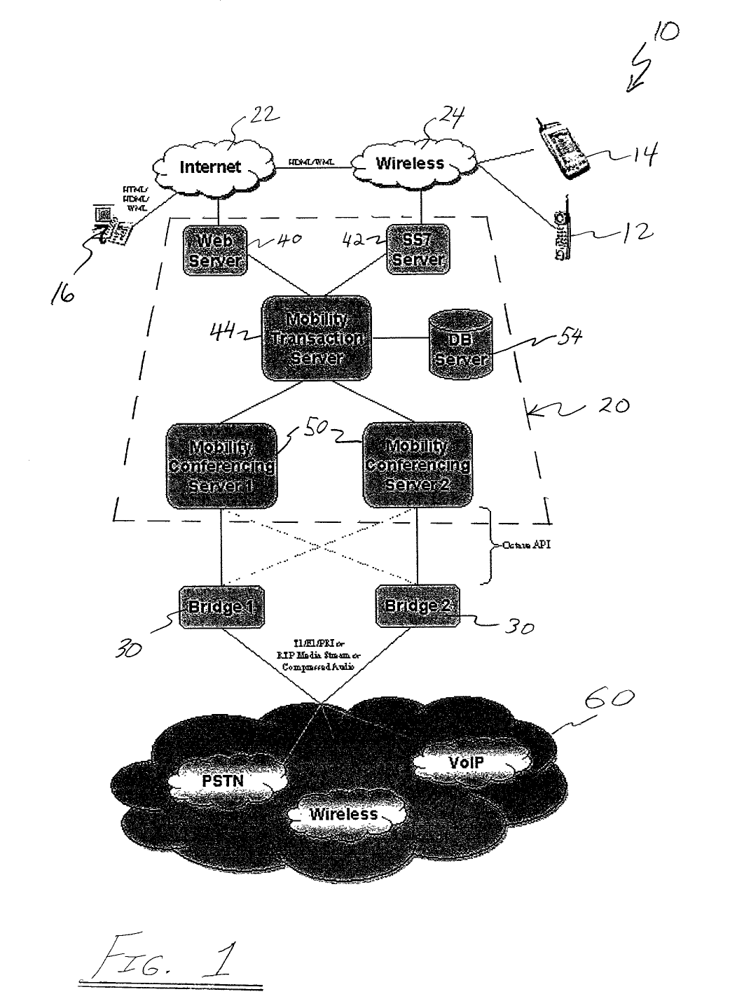

FIG. 1 depicts a preferred conferencing system. The conferencing system 10 may be accessed by, for example: (i) a wireless device such as a cellular phone 12 or PDA 14, or (ii) a conventional wireline device such as a computer 16 that accesses the Internet. The various wireless and wireline devices provide commands to and receive data from a conferencing server 20 via data networks such as, but not limited to, Internet 22 and/or wireless network 24. The conference server 20 is preferably configured and arranged as a redundant system that includes a plurality of servers (e.g., Sun Solaris servers) to provide backup in the event of failure of one or more of the servers. The plurality of servers are preferably managed by a load balancer (see Resource Registrar, discussed below). A user uses wireless or wireline communications channels to interface (e.g., using a browser) with server 20 to perform functions such as conference control, administration (e.g., system configuration, billing, reports), conference scheduling, and account maintenance.

The system 10 preferably also includes a plurality of conference bridges 30. An example of a preferred conference bridge 30 is the OCI-1000 conference bridge available from Octave Communications, Inc. In one embodiment, the conferencing system 10 is a dual bridge system that supports up to 2688 ports. The conference bridges 30 are preferably arranged so as to provide system redundancy, such that if one bridge fails, one or more of the other bridges assumes its workload. Each of the conference bridges 30 is configured and arranged to receive audio from conference participants via various communication channels 60, such as the public switched telephone network (PSTN), wireless networks, VoIP, etc. These channels include, but are not limited to, T1, E1, T3, and ISDN. The server 20 preferably communicates with the bridges 30 via an application programming interface (API). Details of the conferencing platform may be found in co-pending application entitled “Scalable Audio Conference Platform,” Application Ser. No. 09/532,602, the contents of which are incorporated herein in their entirety by reference.

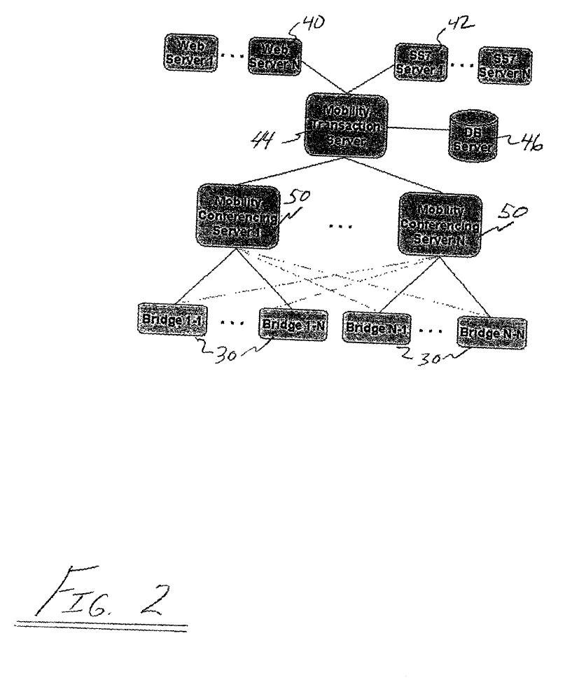

Referring to FIGS. 1 and 2, the conference server 20 preferably includes a plurality of server components such as a web servers 40, SS7 servers 42, mobility transaction (MT) server 44, database server 46, and mobility conferencing (MC) servers 50. The web servers 40 can preferably be used to create a list of people to conference with. They are preferably conventional HTML-based web servers and include pages for capturing names and phone numbers which then go into database server 46. The web servers 40 are also capable of retrieving data from the database 46 and dynamically generating wireless mark-up language (WML) when communicating with wireless devices 12, 14 (see FIG. 1).

Mobility Transaction (MT) Server

The MT Server 44 handles and processes incoming messages, preferably via a thread pool. A thread pool is a collection of threads, each thread being a request for one or more services. For example, an incoming message from a web page may request account validation. A thread would pick up this message. It would then make a call into the logging component and another call to the database (DB) interface to perform the validation. The thread would then send the response from the DB back to the requesting web server 40, make log entries, update statistics, and return to the pool. The thread is a resource, and after returning to the pool it is ready for re-use. I.e., each thread is kept track of via software, and when it is done being used, it is marked as available for re-use. System behavior for all messages is deterministic. This means that a Message Sequence Chart or similar diagram can be drawn for any message, showing repeatable behavior for that message; i.e., the message causes a defined set of subsequent message behavior to take place.

Exemplary messages include, but are not limited to: (1) Create a “Conference Now” Conference; (2) Notify Users of Conference; (3) Create & Modify Account; (4) Activate & Deactivate Account; (5) Verify Account (given user name and password); and (6) Create & Modify Team Lists.

During the processing of incoming messages, the MT Server 44 creates log entries and updates statistics.

Each software component that waits for messages preferably provides message queue functionality. A preferred message queue component monitors the socket waiting for incoming messages. Incoming messages are received and then passed to an incoming message queue. Incomplete messages (messages without a specified terminator) are not placed on the queue, but are discarded. A “dropped message” event is recorded and the partial message is logged.

Two thread pools support the message queue. The pools are preferably configurable as to the number of threads. The first pool supports receiving messages off, for example, the wire, queuing them, and handling receipt event logging and statistics. This first pool also handles immediate response messages such as keep-alives (messages checking whether the receiving component is functioning). The second pool performs actual message processing.

A Resource Registrar (RR) component, preferably located in MT Server 44, is responsible for managing all conferencing resources. When it starts, it contains no resources to manage. As Mobility Conferencing (MC) Servers 50 come online, they are assigned by the MT Server 44 a list of bridges 30 to control. Once an MC Server 50 has made a bridge connection, it informs the RR of the bridge's resources - e.g., number of lines, number of conferences, number of trunks, and the names of the trunks, as well as their types (e.g., dial-in vs. dial-out). Trunks can be assigned for service as either dial-in only, dial-out only, or mixed dial-in/dial-out. The name of the trunk may be used to determine how the lines within the trunk should be used. The RR in turn manages the resources so communicated. A dial-in conference is one where users dial in to the conference via some telephone number. A dial-out conference is one where the conferencing bridge dials the users and they answer and are conferenced. “Dial-in” is also referred to herein as a “Meet-Me” conference.

Any component that requires a conferencing resource will make a request of the RR. This request may be for multiple resources, such as 10 lines and a conference. It may also contain some additional information or restrictions - for example, a request for 2 more dial-out lines on Bridge 7.

The RR component preferably also handles load balancing. Load distribution, or balancing, determines how conferences and lines are distributed among bridges 30 within a system 10. The MT Server 44, through the RR, tracks the current line usage for all conferences on all bridges 30 within the system. When a request for a line is made, the RR determines which line on which bridge to allocate. The determination is based on several factors. The initial factor is current bridge load. Other factors include the parameters of the request, which may include the type of line (e.g., dial-in or dial-out), number of bridges, service state, Meet-Me bridge status, etc. For example, in selecting a bridge to handle the call, some bridges might be dedicated to dial-in vs. dial-out calls. “Meet-Me” bridge status refers to the status of dial-in dedicated bridges. The RR might decide to, e.g., allocate a dial-in call on a particular bridge, for example, based on how busy “Meet-Me” bridges are at the moment. “Service state” refers, for example, to whether a particular bridge is down for service.

The resource request may be made by, for example, an external application or the MT Server 44 itself in response to, for example, a “conference now” request. Again, the RR on MT Server 44 allocates resources such that the load is, for example, distributed evenly among the controlled bridges 30. If the request is for a conference and there is no room it, the requesting party will be told, preferably via a recorded speech message. If the requester is a Web client, they will be sent an error page. If the user is a dial-in user, they will be played a prompt and disconnected.

Prior to requesting any resources, an application preferably must register with the RR, for example by sending a registration request. In response to the registration request, the RR returns an application identifier (appld), which is used in all subsequent resource requests by the application.

A preferred MC Server 50 handles all incoming calls on its bridges 30. The system is configured to enable support for more than one application on the same pool of servers and bridges. For example, a customer might develop its own application that uses some of the lines and trunks, and this would co-exist on the same system as server 20. Initially, an MC Server 50 sends a “register me to watch all lines on Bridge X” (or similar) message to the RR. If the lines are already being watched (by an external application) the request fails. Otherwise, watch registration is granted. If a line becomes active due to a dial in, then the MC Server 50 sends a “line dialed in and is now active” message to the RR. The RR then automatically registers the line to the MC Server 50. For an incoming call, the particular MC Server to be responsible for this call does not have to be set until the time of the call. For example, via SS7 ISUP (Integrated Services User Part) call control protocol, a particular MC Server could be assigned to handle that call. In practice, it might be the same MC Serveras initially handled the incoming call request, but not necessarily so. If another application makes a request for a line, the RR may choose to supply a registration for a watched line. A “watched line” is a line that the application is responsible for. A watched line that is not in use or considered registered can thus be given to another (perhaps external) application.

A race condition may occur if, between the time an application requests a line and actually uses it, an incoming call is routed to the line. In order to handle this situation, when the application attempts to use the line and the attempt fails, the application will send a “the line you gave me is bad, give me another one” message. For example, an application might request to use line “xxx” for an outgoing call, but after requesting that specific line, the application could get an indication that an incoming call has appeared on that particular line. The RR will respond with another line and will mark the line as “in use” by the application that was registered to watch it.

Preferably, the RR verifies that resources have not been lost by an application and keeps track of the owners of the various resources within the system.

MC Server 50 communicates any changes in bridge resources to the RR. For example, if a trunk goes into red alarm, the MC Server 50 will notify the RR, which will then clear all line registrations and change the status of those lines to “not available.” A red alarm is a network alarm with a particular assigned meaning (see, for example, IETF RFC1406, at www.ietf.org).

A Watchdog component triggered by the RR ensures that processes or components within the system that have registered with the MT Server 44 are functioning properly. This is done in two ways. First, normal command message flow is monitored. This can be performed using various techniques known to those skilled in the art, such as reading the log files produced by the various processes. Second, in the absence of normal command messages, the Watchdog will send “keep alive” messages that are immediately returned by the processes being watched. If the Watchdog determines that a process or component has failed, for example, because there is no normal message flow and the process or component does not respond to “keep-alive” messages, the Watchdog notifies the RR, which in turn initiates fail-over actions. For example, the Watchdog may monitor a bridge server and notify the RR when the server fails. A “keep-alive” is a software mechanism by which two processes, either on the same or different processors, can detect whether one has stopped functioning. This is typically accomplished by sending messages between the different processes at some predetermined interval. If one process stops getting those messages, it detects that a problem has occurred and takes some corrective action.

MT Server 44 may also, for example, send keep-alive messages to each MC Server 50. Again, keep-alive messages are not sent to an MC Server 50 if other communications have occurred between it and the MT Server 44. If the MT Server 44 does not receive acknowledgment of a message, it will preferably make N retries before declaring the MC Server 50 failed. An MC Server 50 can also send an “I am failed” message to the MT Server 44 when it is being shut down gracefully.

When an MC Server 50 is declared failed, the MT Server 44 takes control of the failed MC Server 50's bridges by assigning its bridges to other MC Servers. If, during the takeover process, the “failed” MC Server 50 begins to respond, the takeover continues nevertheless. The MT Server 44 preferably requires that the previously failed MC Server 50 respond to keep-alive requests for N minutes before reassigning bridges back to that server. Failed bridge servers are dealt with in an analogous manner.

After the MT Server 44 declares an MC Server 50 failed and has successfully taken over control of its bridges 30, it ceases to attempt connection to the failed MC Server 50.

When the MC Server 50 becomes operational, it sends a message to the MT Server 44 indicating that it is back. The MT Server 44 then monitors the MC Server 50 by sending keep-alive messages for a configurable period of time. When the MC Server 50 has stayed up for the appointed time, the MT Server 44 begins to assign new conferences to it. Conferences that are running on the “backup” MC Server 50 are not interrupted. Eventually, conferences running on the backup MC Server 50 will end and the original MC Server 50 will be in control of its original bridge's resources. At this point, the backup MC Server 50 will sign out of the bridge 30 by sending a particular “logout” protocol message to the bridge, upon which the connection to the bridge will be released and any resources depending on that connection will also be released.

If MC Servers 50 responsible for certain bridges 30 have not started, and resources are running low, the RR may, for example, trigger a Watchdog to initiate fail-over procedures in order to secure more lines by, for example, providing an alternative MC Server and/or conferencing bridge to handle the request(s).

The MT Server 44 also preferably includes a Configuration Manager, a Presence Manager, a Notification component (“Notifier”), a Logger component, and a CDR/CODR Manager.

The Configuration Manager component stores and dispenses configuration information. The RR queries the Configuration Manager to learn of system resources. It may provide some of this information to, for example, an SNMP (Simple Network Management Protocol) agent, preferably associated with each bridge. In one embodiment. the SNMP agent is HP OpenView compatible. The agent speaks directly to the bridge (using, for example, ODK (Octave Developer Toolkit) or similar software) and, for example, extracts information from incoming events. Such information may include CallerID (incoming phone number), and event date and time.

Preferably, configuration information may be changed to some extent without requiring a system restart. In this case, a flag is kept, indicating whether a configuration item has changed, and both the “active” and “set” options are stored. The “active” setting is returned unless the “set” option is specifically requested. The “set” option is written to persistent storage immediately after being set. Upon system restart, the “set” option replaces the “active” option, i.e., the configuration change takes effect.

The Presence Manager retrieves presence information, via a Presence Interface component, from a third party Presence system and determines the method by which a person or group is contacted. A Presence system provides contact information for individuals or groups of individuals. Depending on the exact presence requirement, this component may be implemented as stored procedures within the database. “Stored procedures” are a software mechanism associated with database access routines for efficiently retrieving database contents based on particular access rules. In the context of storage of Instant Messaging (IM) Presence information, IM services such as AOL AIM, MSN, Yahoo, ICQ, etc., allow users to detect whether someone is online or offline. This presence information and preferably other similar presence information are stored in the database of a preferred embodiment.

A Presence Service Data Stream component represents a preferred external source of presence information, such as that described above (AOL AIM, etc.). For a given conference call, the Presence Manager may or may not be used.

In one embodiment, the presence information is displayed to an end user setting up a conference call and the end user manually selects the number to use. The presence indicated number is selected by default. “Presence indicated number” refers to the automatic detection of whether someone's home number or work number, for example, should be used for a call. Such detection is based on presence information used by the Presence server, using a service such as AOL AIM, etc. Preferably, there is a system level option to trust or not trust the presence data. If the presence data is not trusted, only the group member names would be displayed. This option is preferably made available on a user account level and on a group member level. A group member level identifies a group of users can be identified within the system so that defaults can apply to the whole group and not just individuals.

A Notifier component queues requests for notifications to be sent, e.g., via Short Message Service (SMS) or Simple Mail Transfer Protocol (SMTP). These non-time critical messages will be sent when resources permit. The text of the messages will have been determined for example by a user. For example, the user may input the desired text via a user interface method, such as via HTML web screen, Wireless Application Protocol (WAP) (either HDML or WML) mobile phone Internet browser, or some other user interface. Each SMS message preferably is formatted to allow a user to dial directly into, for example, a conference call, based on the message, instead of having to key in the number. In particular, as is known in the art, SMS-handling software in mobile phones can detect embedded phone numbers and display them in a highlighted manner, so the user can then simply put the cursor on the field including such number and press “Send” on the mobile phone handset to have that number dialed.

The Logger component logs various levels of information and is preferably configurable at runtime and thread-safe. Levels include, e.g., errors only, messages, program flow, etc. “Thread-safe” means that code is built so that it can be used in multiple threads at the same time, and that no two threads attempt to modify the same data location at the same time. Thus a logging routine can be used by multiple processes and write entries into a common log file.

The CDR/CODR (Call Detail Record/Conference Detail Record) Manager component is given information about a call or conference and makes the appropriate entries in a file and/or in the database. CDR is a billing record summarizing each line that was in a conference; CODR is a billing record summarizing the entire conference. CDR/CODR records may be queued based on observed I/O performance, i.e., when system activity is determined to be high, the CDR/CODR Manager may choose to increase the buffer size so that records are actually written to the disk less often, but contain a higher number of CDR/CODR messages, for efficient disk access.

Mobility Conferencing (MC) Server

A preferred MC Server 50 is responsible for performing conference control activities for conferences on lines that are located on the bridge or bridges to which it is assigned. For example, MC Server 50 may command the conference bridge 30 (see FIG. 1) to dial a list of telephone numbers and monitor the bridge 30 when those telephone numbers are answered. Bridge communication is done, e.g., using the ODK or other similar software. Communications are preferably implemented as a set of lightweight messages (i.e., small messages that contain only minimal information), with each ODK connection running as a separate process. Each bridge 30 preferably has an MC Server 50 sub-process running. The sub-process handles the messages from the MC Server. MC Servers 50 are preferably identically configured, to provide behavior that is consistent throughout the system. The MC Server 50 is preferably capable of supporting externally-developed applications and is responsible for some interaction with callers, such as playing prompts, collecting DTMF digits, transferring calls into conferences, etc.

The MC Server 50 preferably includes a DTMF IVR system, moving users into appropriate conferences, playing prompts, etc. During many of these functions the MC Server 50 must communicate with the MT Server 44. The MC Server 50 will send CDR and CODR information to the MT Server 44 for storage. Communications between MC Server 50 and MT Server 44 are preferably via a Unix version of the “C” Octave API, or other similar software or toolkits.

Each MC Server 50 is also responsible for monitoring the state of its bridges 30 and sending bridge status information to the RR in MT Server 44. This eliminates the need for the MT Server 44 to have a direct network connection to each bridge 30. MC Server 50 preferably has a setting for the maximum length of time without bridge communication. The timer is started after connection is made and reset after every successful ODK function call and after each received event. If the timer goes off, MC Server 50 sends a sanity request to the bridge 30 and the timer is reset. If the sanity request fails, a message is sent to the MC Server 50 that a bridge 30 is not responding. The MC Server 50 then notifies the RR that the bridge 30 is out of service. If the sanity request fails, then the ODK connection must have been severed. In other words, if a message is sent but there is not a response from the bridge, then the protocol connection must have failed (been “severed”), and hence some recovery action is necessary. The MC Server 50 will continue to attempt login to the bridge 30 periodically. If a successful connection is made, the MC Server 50 will inform the RR of the connection status change and the associated resource changes. After the MC Server has successfully logged in to the bridge, it can handle calls, so notifies the RR.

The MC Server 50 preferably has state machines (SM) for all lines and conferences. The default behavior of the SM is to do nothing. The SM is used for unregistered resources. The SM used for watched lines provides IVR and conference entry functionality for incoming callers. An event handler within the MC Server 50 takes line status indications, gets the SM from the array, and sends in structure. The SM then handles it. In other words, if no application has registered to be responsible for a particular line, the SM provides a default mechanism for handling calls on that line.

In a preferred embodiment, an OCI-1000 bridge is used as the standard bridge 30. It is preferably configured for external call control to enable a “higher level of low level call control.” This means that the line handling can be under the control of software that can respond in various ways depending on the requirements, on a real-time basis. Each MC Server 50 preferably has one OCI-1000 bridge, although having more than one bridge per MC Server is within the scope of the present invention. MC Server 50 and bridges 30 preferably communicate using the OCI protocol (e.g., Octave API), although those skilled in the art will recognize that other protocols could be used without departing from the scope of the invention described herein.

A preferred HTTP based web server 40 is configured for optimal performance and to ensure security. This includes popular browser security support like SSL, TSL, etc., as well as web server digital certificates (see http://www.verisign.com/products/site/index.html for examples of this). A preferred Web server 40 provides services for HTML, HDML, and WML pages to wireless or desktop devices.

An SMTP Server component is a mail server used to send and receive notifications. An SMS Service component allows short messages to be sent and received.

Preferably, wireless phones can be used to access the system. A wireless phone can be used, for example, to invoke a Feature Code Conference, invoke the IVR system, or dial into a Meet-Me conference. A “Feature Code Conference” is a conference, initiated via an SS7 interface to a MSC (“Mobile Switching Center”), that is invoked by the user on a mobile phone via a “feature code” or “short code.” For example, the conferencing feature might be offered to the customers via pressing *4 on their mobile phone. A “Meet-Me” conference is a conference that participants dial in to. Additionally, if the phone is equipped with a data connection and a browser, it can access HDML, cHTML, or WML pages. Also wireless enabled and/or web-enabled Personal Data Assistants (PDAs) capable of rendering, e.g., HTML, cHTML, HDML, or WML web pages can be used to access the system.

A standard phone can be used, for example, to access a Feature Code Conference, the IVR system or dial into a Meet-Me conference.

SS7 server component 42 receives data from wireless or wireline service providers indicative of, inter alia, a subscriber's telephone number and group number. MT Server 44 can in turn use this information to search the database 46 in order to locate phone numbers for the people in the group associated with the incoming number in order to set up the conference.

The SS7 server 42 includes SS7 hardware and software drivers and handles incoming SS7 ISUP messages, providing a Feature Code Conferencing service. Preferably, SS7 Server 42 is configured in duplex mode (a redundant configuration), such that if one link goes down it will automatically switch to another link with no loss of state.

Again, the incoming ISUP messages contain the caller's phone number and group number to be dialed, which the SS7 Server 42 preferably sends to MT Server 44 in the form of a “feature code conference” message. The MT Server 44 validates the caller's account based on the phone number and the group.

On successful validation, the conference is created and the SS7 component 42 is provided with information required to route the call to the correct conference. On failed validation, a call is routed to a port on a bridge 30 to play an error message. Once the message is played, the call is dropped. A configuration option may allow a caller to speak with an operator.

A database (DB) interface preferably hides the specifics of database access and returns data in native data types, not database oriented types (i.e., record sets, etc.).

In one embodiment, the conference server 20 includes two or more MC Servers 50, each controlling one or more bridges 30, and an MT Server 44. The MT Server 44 keeps track of and controls the allocation of line and conference resources on each bridge 30.

System components preferably can be started and restarted in any order. For example, Web server 40 can be started and restarted independently of other system components since it only provides input to the system. Other components do not rely on it being up. The Web server 40 uses configuration information to locate the MT Server 44. The Web server 40 will begin to process HTTP requests immediately. If a request to the Web server 40 is made that requires communication with the MT Server 44 and MT Server 44 is unavailable, an error will be generated and displayed to the user.

When started, the SS7 server 42 verifies that an MT Server 44 is available prior to handling incoming SS7 messages. If the MT Server 44 is not immediately available, the SS7 server 42 will continue to request a connection until one is made. The SS7 server 42 uses configuration information to locate the MT Server 44.

When bridges 30 start, they sit in an idle state until an MC Server 50 signs in and begins to handle events. Incoming calls that reach a bridge 30 prior to an MC Server 50 initiating control will be answered and placed on hold until control is initiated. These incoming callers will hear only silence.

When MC Servers 50 are started, they send a message to their MT Server 44. The MC Servers 50 use configuration information to locate an MT Server 44. If the MT Server 44 is unavailable, the MC Server 50 will continue to request a connection until one is made. When a connection is made, the MT Server 44 will inform the MC Server 50 of the location of the bridge(s) that it is to control. For each bridge 30 that an MC Server 50 is told to control, it will attempt to sign into it. If a connection cannot be established with a specific bridge, the MC Server 50 will continue connection attempts. When a connection is made to a bridge, the MC Server 50 will determine the resources available and will report that information to the MT Server 44.

When the MT Server 44 is started, it immediately begins accepting requests from SS7 Servers 42, Web Servers 40, and MC Servers 50. Requests that require unavailable resources will be rejected with appropriate error messages - for example, “Database not available” or “Resources not available.”

The MT Server 44 preferably uses only the resources that are available as reported by the MC Servers 50. When resource usage reaches a configurable percent usage, if there are other bridges 30 that are configured to be controlled by any unstarted MC Server 50, the MT Server 44 will consider the unstarted MC Server 50 as failed and will begin the backup (i.e., fail-over) process in order to secure more resources.

The system 10 may scale to include Mweb servers 40, N SS7 servers 42, 0 mobility conferencing servers, and P bridges 30. This scalability is depicted in FIG. 2.

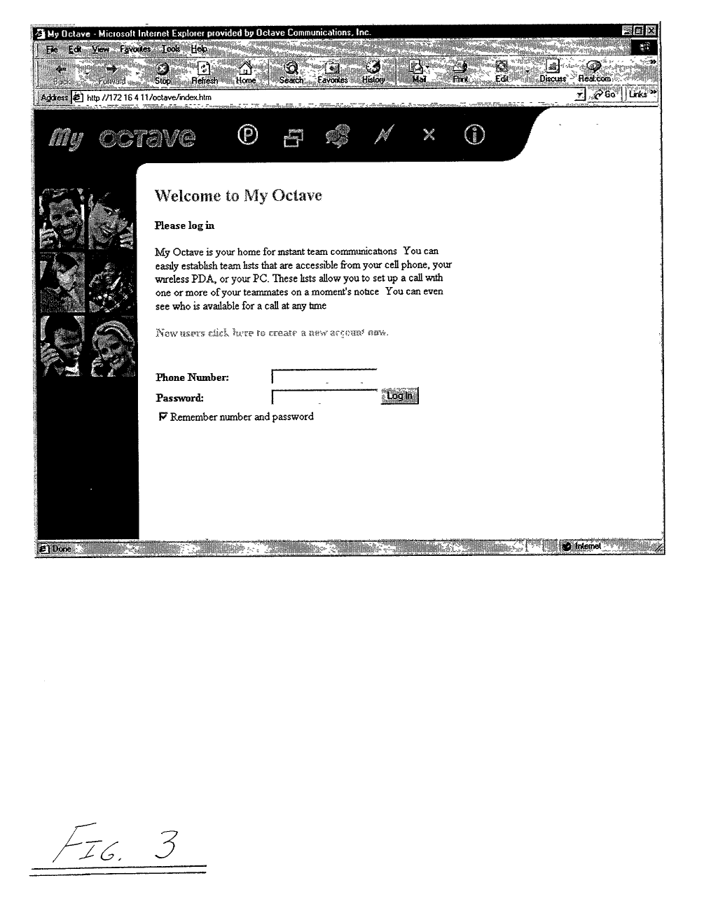

FIG. 3 shows a preferred user login screen that allows the user/subscriber access to the conferencing system via their cell phone, wireless PDA, or personal computer. As illustrated in FIG. 3, the user provides a telephone number and password in order to log in. Of course, there are various other combinations of login authentication techniques that may be employed in order to properly authenticate a user/subscriber.

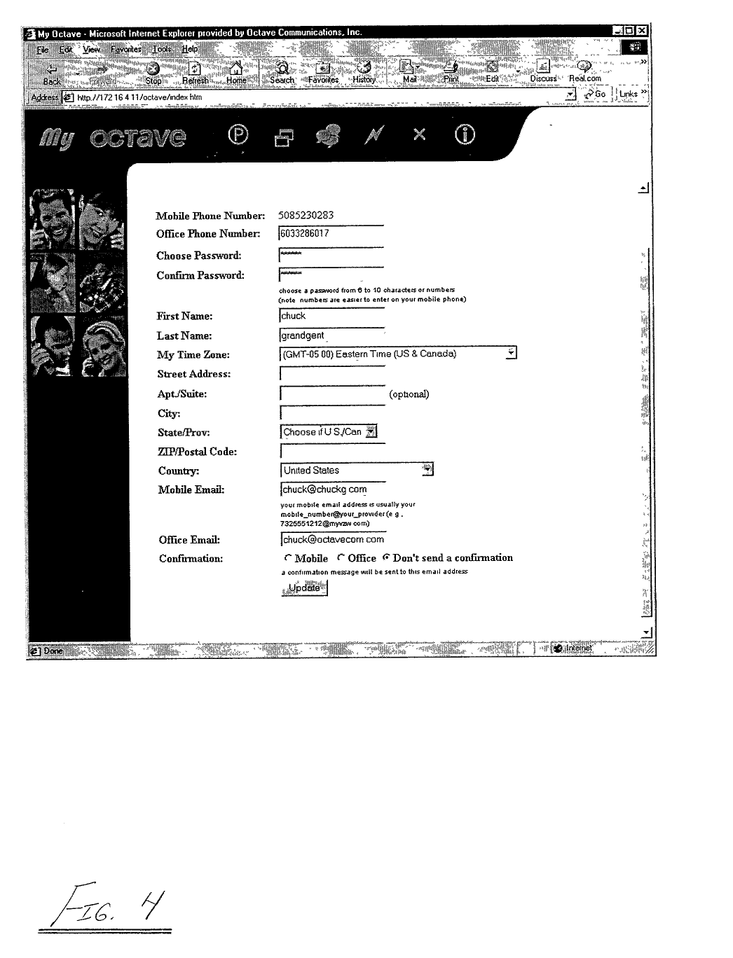

FIG. 4 shows a configuration screen that a user may use to set up an account the first time the user enters the system or may call up in order to change their profile.

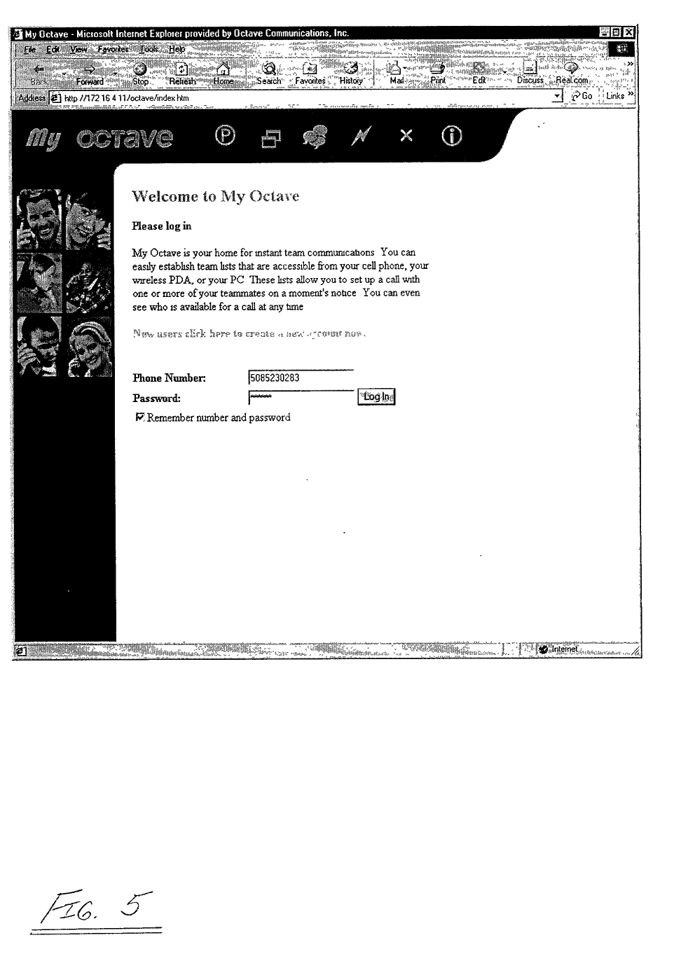

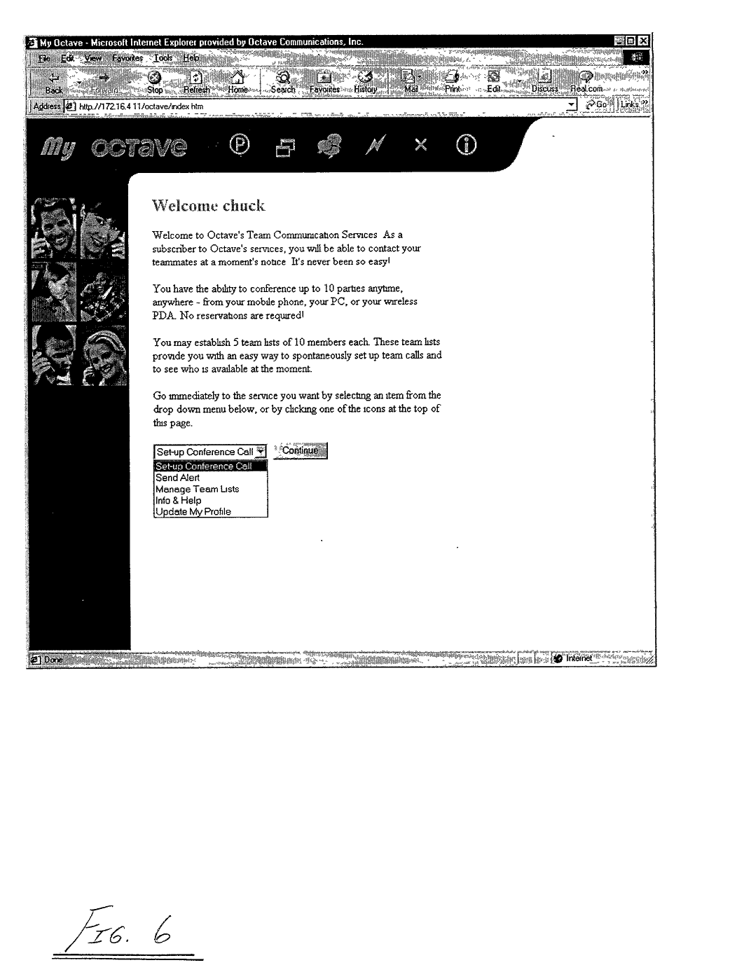

FIG. 5 shows a screen that includes a phone number field and a password field filled in. Once a user has been properly authenticated by the server 20 (see FIG. 1), the screen shown in FIG. 6 appears.

As shown in FIG. 6, a user's welcome screen includes a drop-down menu that allows the user to select a desired conference control feature. For example, the user may elect to set-up a conference call, send an alert, manage a team list or lists, access an information and/or help directory, or update his or her profile.

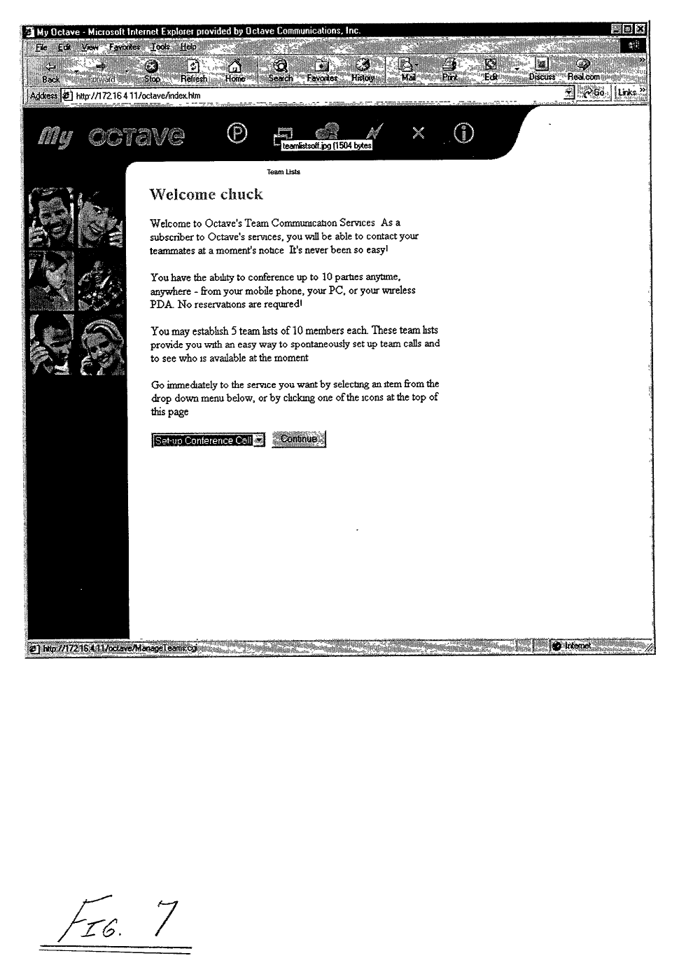

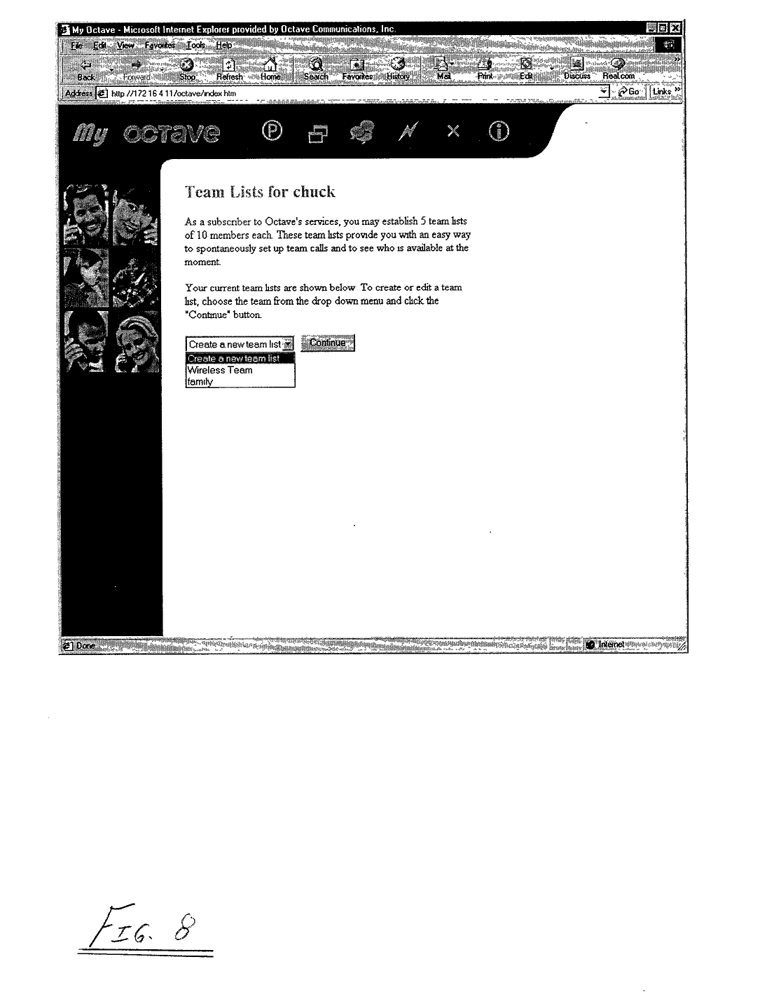

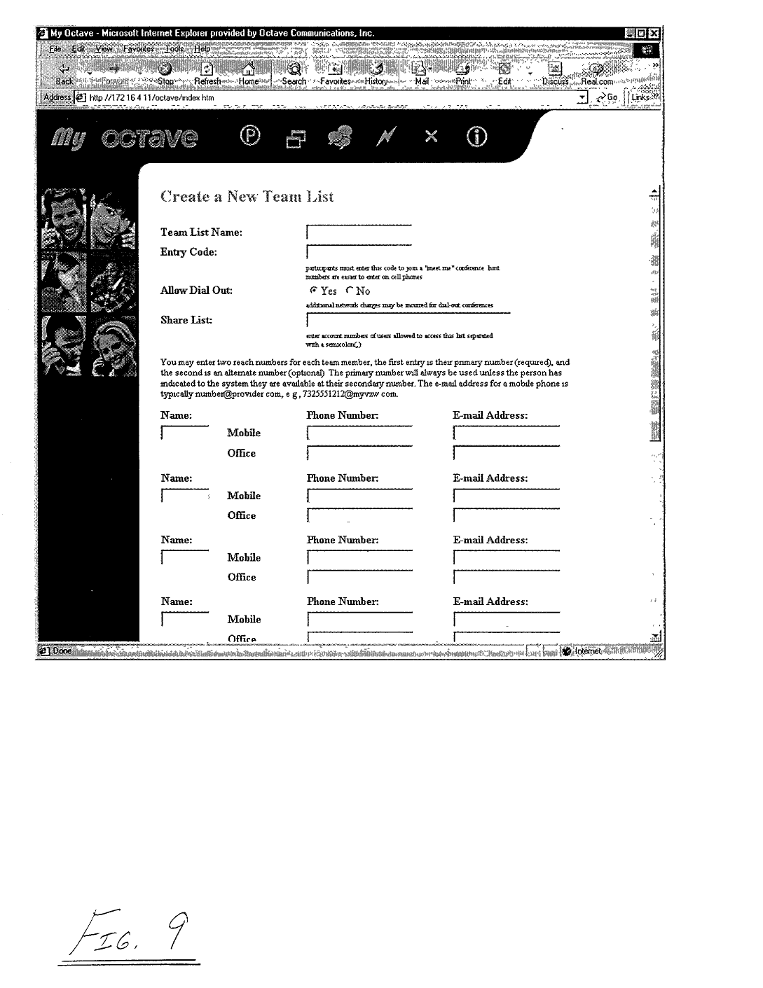

FIG. 7 shows a welcome screen configured by a user to select the set-up conference call feature. Once the user has selected this feature, the screen shown in FIG. 8 appears, displaying a drop-down menu that includes the option of selecting the next task to either create a new team list, create a wireless team, or create a family conferencing list. If the user selects the option of creating a new team list, the screen shown in FIG. 9 appears, displaying various fields for the user to specify a team list name, an entry code, whether to allow dial out, other individuals who may share this list, and identity information regarding participants of the conference. The identity information regarding participants in the conference may include names, mobile and/or office or other telephone numbers, and e-mail addresses.

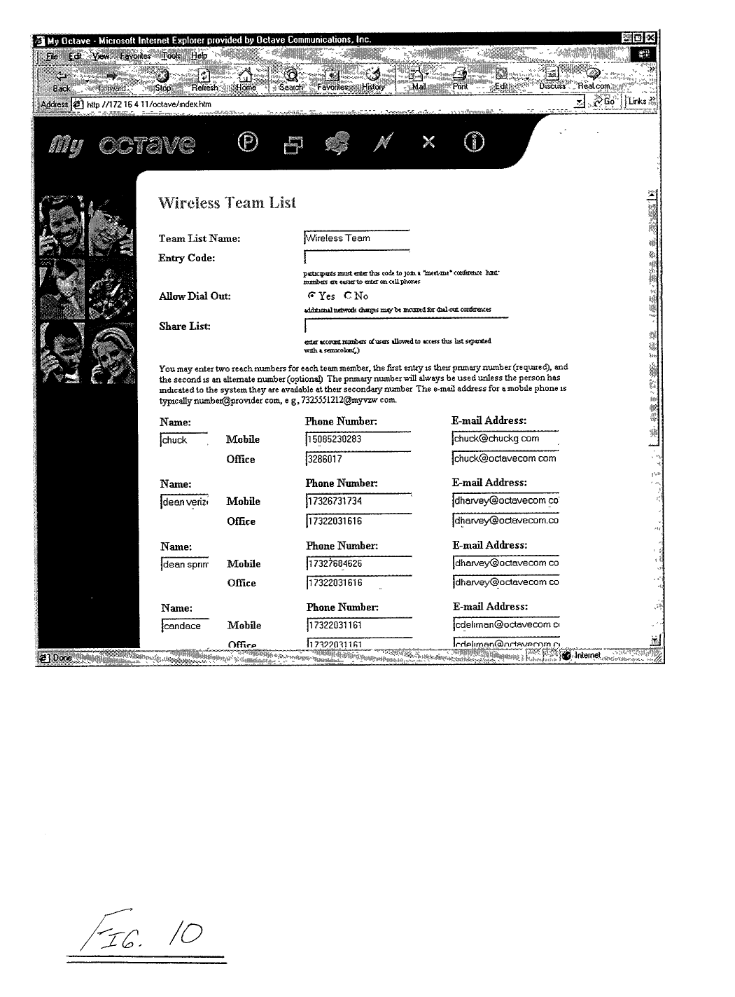

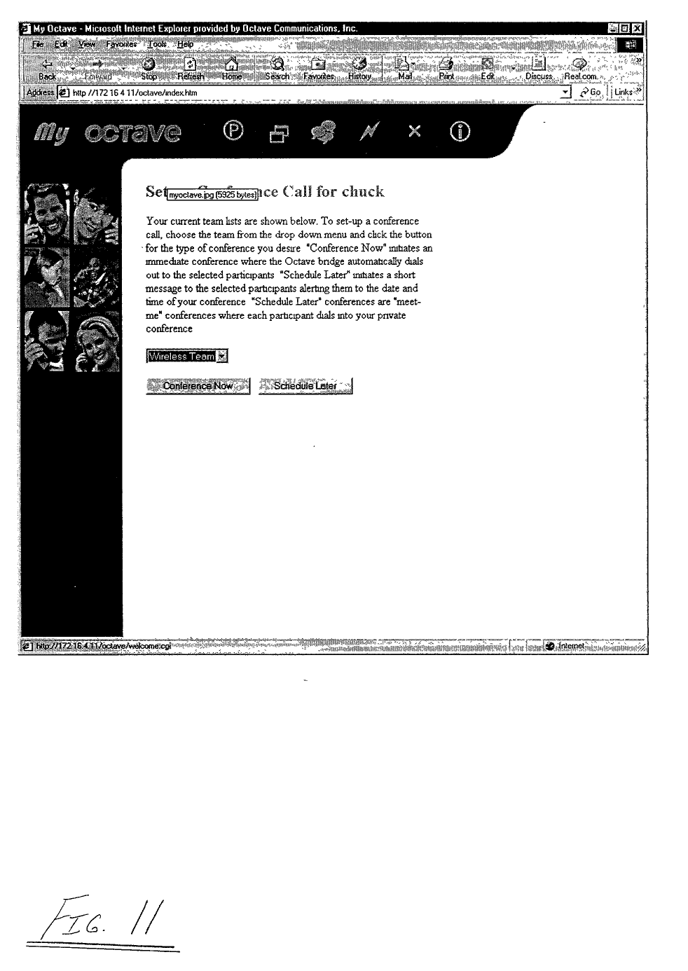

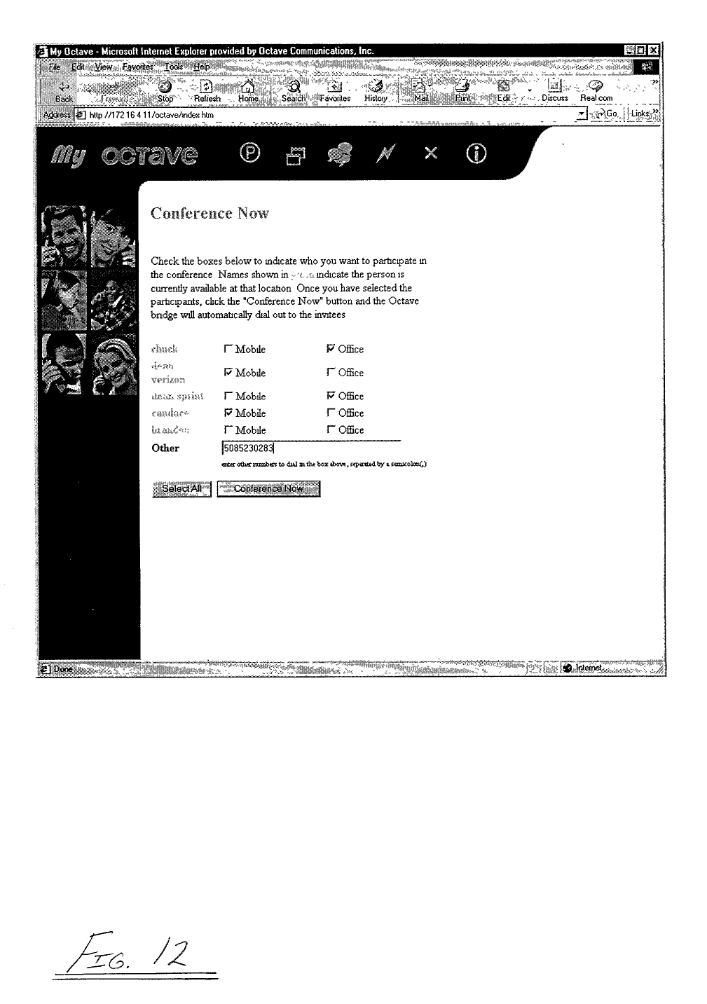

FIG. 10 shows a screen with a completed (i.e., filled in) team list that has been named “Wireless Team.” As shown, the first conference participant's name is Chuck, and his information, including his mobile and office telephone number and his various e-mail addresses, is included in the fields. Similarly, information is entered for team members “Dean Verizon,” “Dean Sprint,” and “Candace.” Once the user has specified this new conference team list, the user may initiate a conference by selecting the team list (as depicted in FIG. 11) and by selecting whether to conference now or schedule a conference for a later time. If the user selects the option of conferencing now, a screen appears as shown in FIG. 12, instructing the user to indicate team members that the user wants to have participate in the conference. As shown in FIG. 12, the system preferably is configured to allow the user to choose between a potential conference participant's mobile phone or office phone. However, the system may be configured to allow conference participants to conference from a home telephone number or any other telephone number. In addition, as shown in FIG. 12, a conference organizer may manually specify telephone numbers for additional conference participants who are not part of the conference team list.

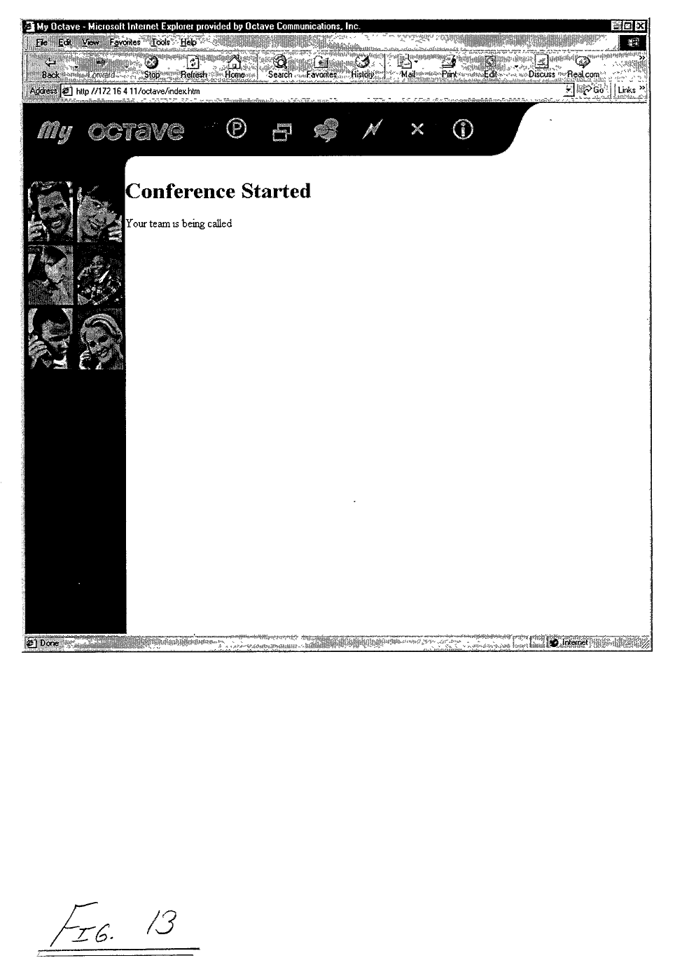

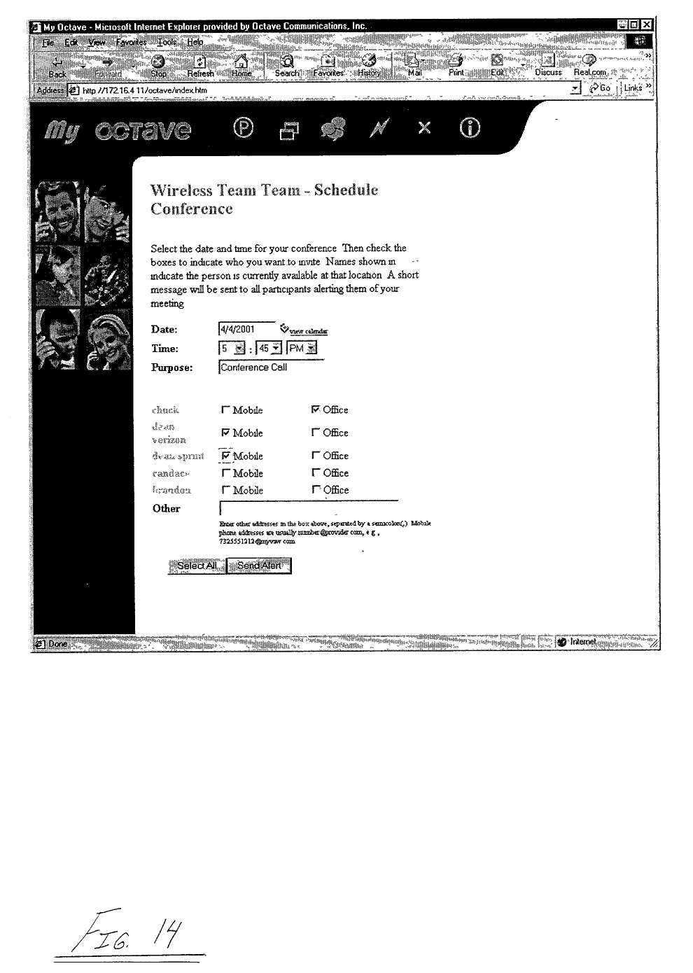

Once the user elects to initiate a conference by selecting “conference now,” the server 20 then displays to the user a screen as shown in FIG. 13, indicating to the user that the team is currently being called. If the user elects to schedule a conference for later rather than to conference now, the screen shown in FIG. 14 is displayed to the user. The user can then select a date and time for the conference and specify a purpose for the conference. Similar to the conference now setup, the user may choose the various conference participants from the team list, with the devices that they should be contacted on. For example, as illustrated in FIG. 14, the user has elected to conference on Apr. 4, 2001, at 5:45 PM. In addition, the user has elected to conference with Chuck, Dean Verizon, and Dean Sprint, but he has not elected to conference with Candace or Brandon.

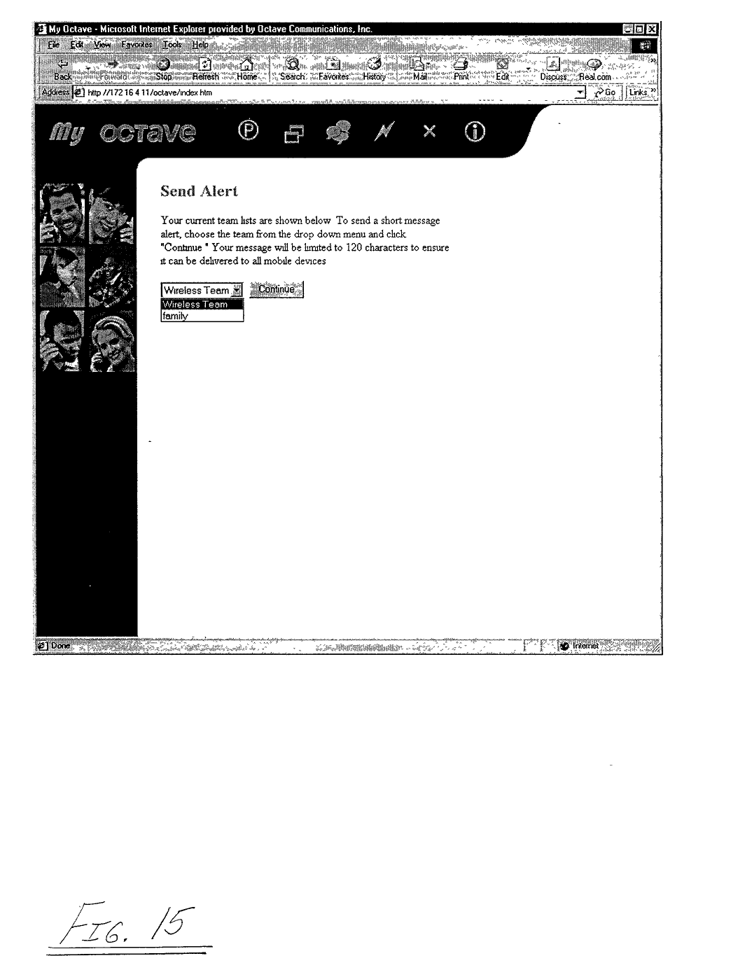

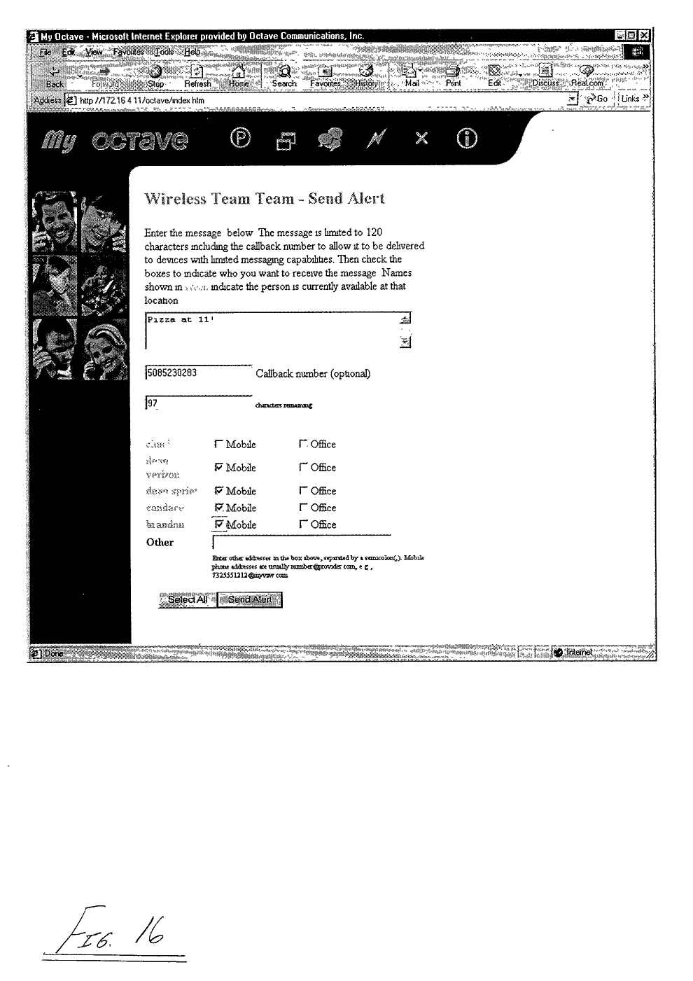

Referring again to FIG. 6, along with setting up a conference call, the user may also elect to send an alert. If the user elects to send an alert, the user is presented with a screen as shown in FIG. 15. The user can then choose which team lists he would like to use to send a short message to the participants on the list. For example, if the user elects to send an alert to the Wireless Team, a screen as shown in FIG. 16 is presented to the user, and the user may enter a text message as shown (e.g., “pizza at 11!”), and provide a call back telephone number. In this embodiment, the message is limited to 120 characters, and as the user types a message into the message field, a counter is automatically maintained to display the number of remaining characters the user has available for the message. Preferably, the user may choose the team members he wants the alert to go to.

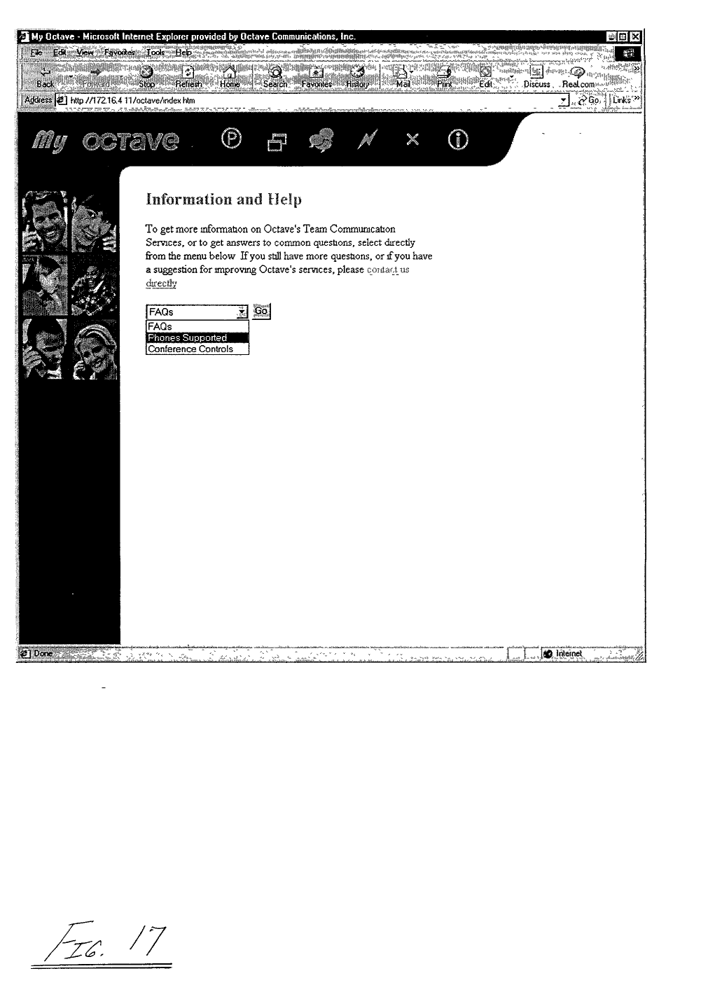

Referring again to FIG. 6, if the user chooses the field indicated “Info and Help,” a screen as shown in FIG. 17 is displayed to the user. From a drop-down menu the user may select a field for Frequently Asked Questions (FAQs), a field entitled Phones Supported, or a field entitled Conference Controls.

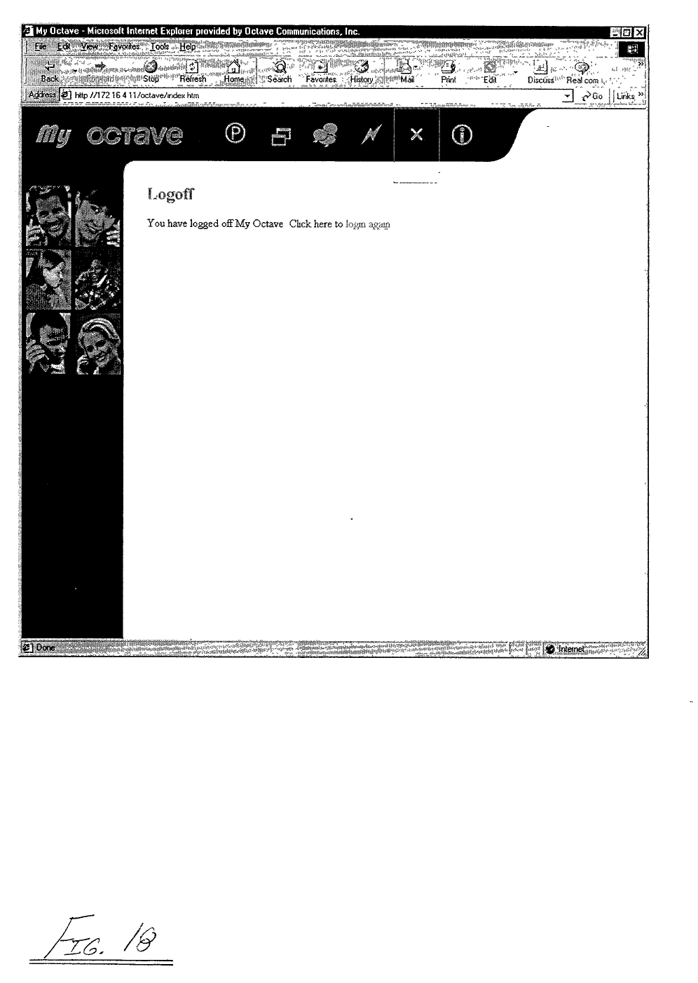

FIG. 18 shows a screen after the user has elected to log off from the server.

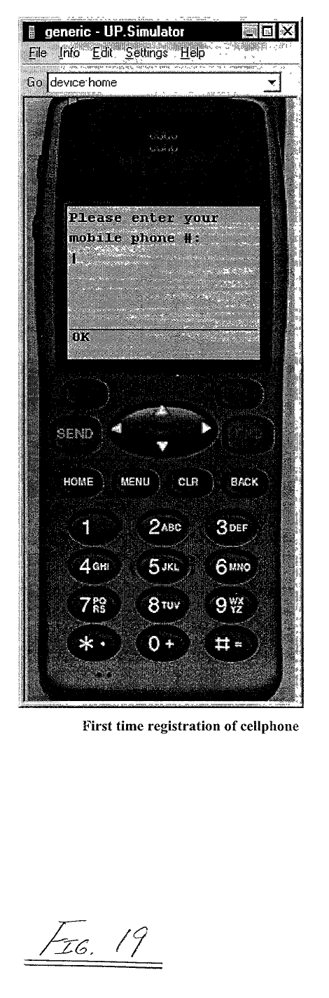

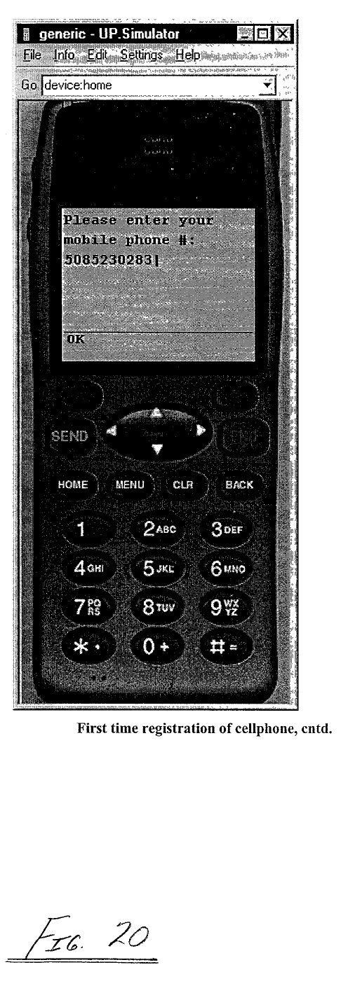

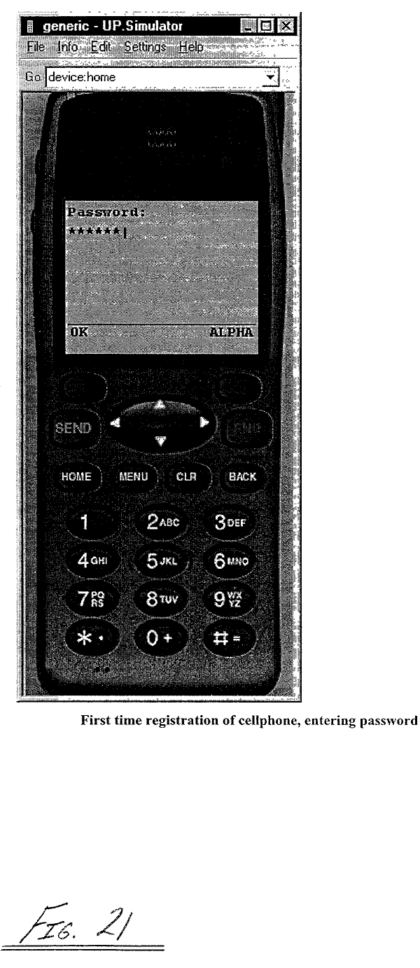

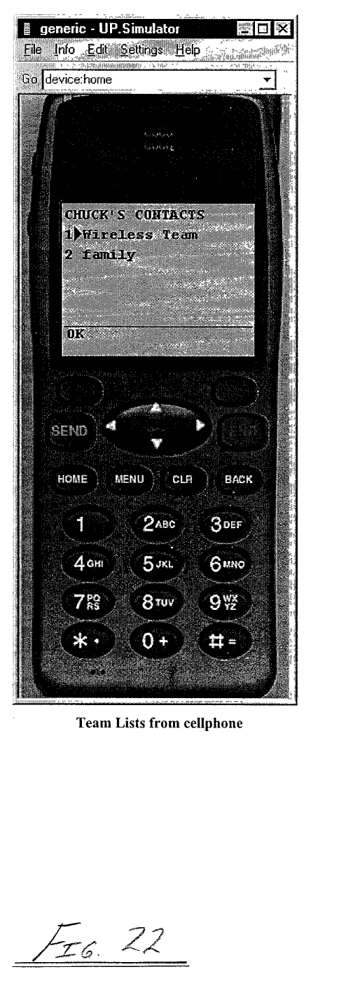

FIG. 19 shows a cell phone screen for first time registration of a cell phone user. As shown on the display screen of the cellular phone, the user is asked for his mobile telephone number. Using the keypad of the cellular phone, the user enters his cellular telephone number (see FIG. 20) and sends that information to the server 20. The server 20 then asks the user for his password (see FIG. 21). Using the keypad on the telephone, the user enters his password and sends that via wireless link to the server 20. Once the server 20 has authenticated the user, the server transmits (for example, in wireless markup language) a page for display on the user's cellular phone. As illustrated in FIG. 22, this screen may display the user's teams for conferencing. For example, for Chuck's cellular phone, conference teams for “Wireless Team” and “Family” are displayed.

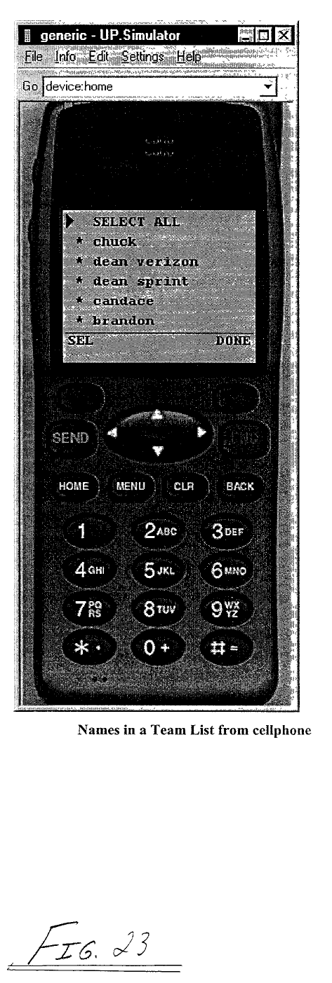

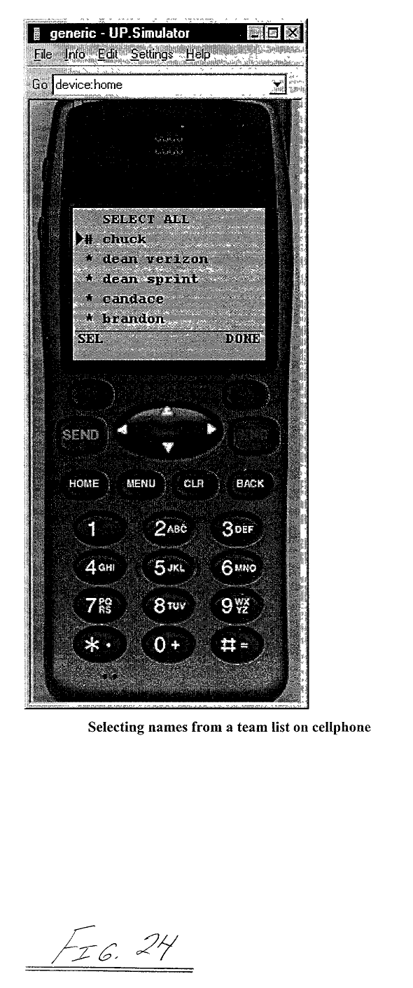

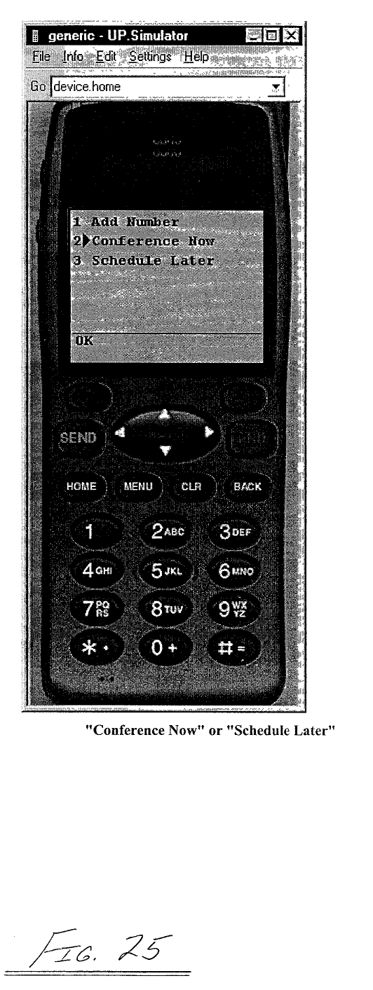

Referring still to FIG. 22, if Chuck elects to conference with the Wireless Team he makes his selection, preferably using the key pad of the cellular phone, and that selection is communicated to the server 20 via the wireless link. In response thereto, the server 20 communicates the team list to Chuck's cellular phone, and that list is displayed on the screen of the cellular phone, as illustrated in FIG. 23. As shown in FIG. 24, the user may select the conference participants to be included in a conference. As illustrated in FIG. 25, the user may choose to add a telephone number, to conference now, or to schedule a conference for a later time.

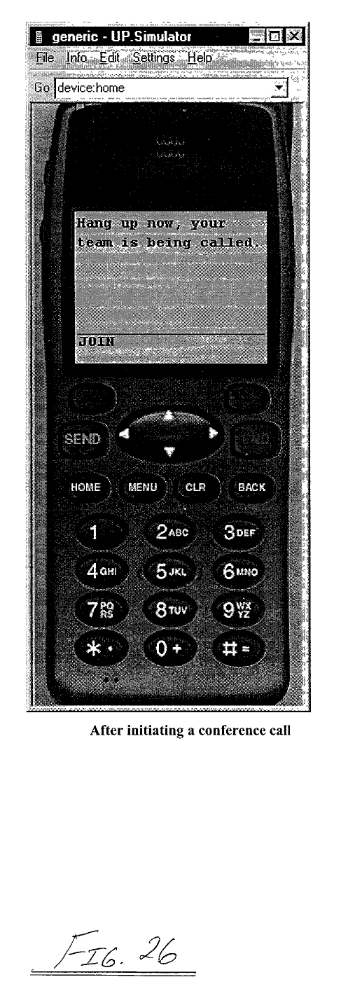

If the user elects to conference now, a message is displayed on his cellular phone (see FIG. 26) instructing the user to hang up now while the conferencing system 10 calls the various conference participants.

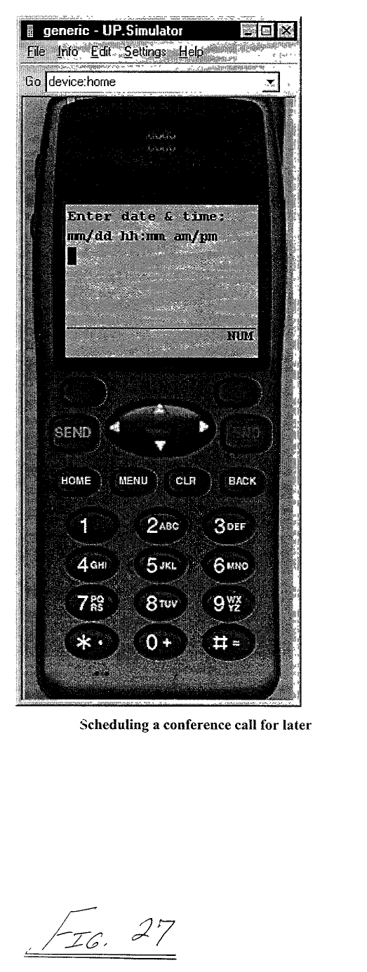

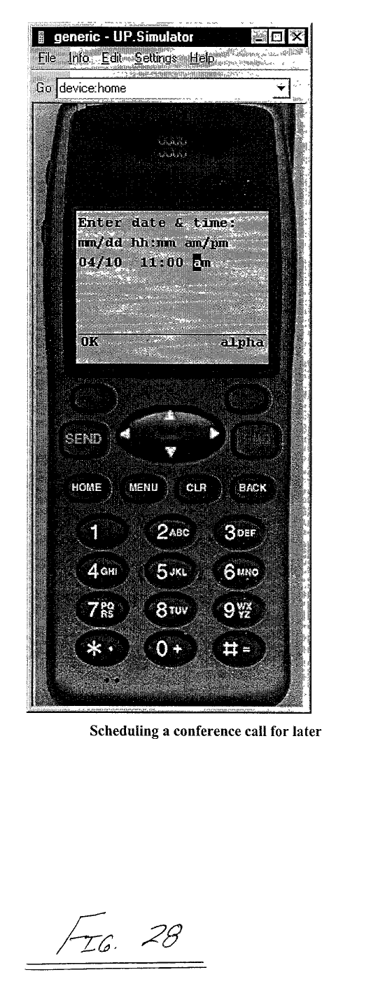

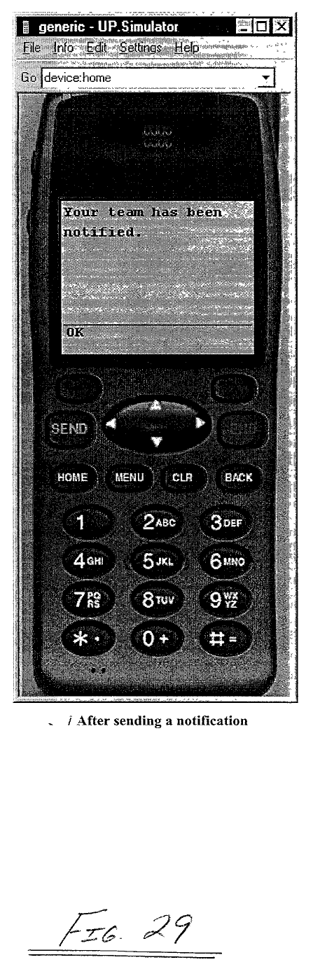

If the user elects to conference at a later time, a screen is displayed as in FIG. 27, asking the user to input a date and time for the conference. Using the keypad of the cellular phone, the user enters the date and time of the conference (see FIG. 28). Following entry of the date and time of the conference, that information is sent from the cellular phone over the wireless link to the server 20, which then communicates the conference time and date to the conference participants based upon their profile information stored in a database. The user setting up the conference is sent a notification (see FIG. 29) that the team has been informed of the conference date and time.

Various use scenarios are described next.

1. Sign In to Mobile Web Site: An initiating user connects to HDML or WML (“WAP”) web site using a wireless phone. The Web server 40 extracts the phone's 20-digit phone ID. The Web server 40 sends an account lookup message to the MT Server 44. It includes the phone ID. The MT Server 44 performs a database lookup based on the phone ID and returns the result along with some relevant account information. If the phone ID is not found, the user will be prompted to enter user name and password prior to logging into the site. This information is then passed to the MT Server 44 for validation. Once this first login has been made, the 20-digit unique phone identifier will be stored in the DB (if not already there). Failed logins are logged. If the phone ID is found and is valid, the user will be automatically logged in. If the phone ID is found and is invalid, the user will be refused access to the site. The Web server 40 extracts the browser type from the HTTP request or user preference and generates the appropriate initial web page.

2. Feature Code and Group Dialed: Initiating user picks up wireless phone and dials *XY, *X being the feature code, Y being the group number. Call setup messaging is routed through carrier's network terminating with an SS7 ISUP message being sent to the SS7 server 42. The message contains the phone number of the dialing phone and group number (Y) in the “A” and “B” fields. Other data such as “correlation” data in the charge number field (to help in billing), and other call configuration data may be present. The SS7 server 42 sends a message to the MT Server 44 requesting account and group verification and to start the conference. The MT Server 44 performs account and group validation. The MT Server 44 creates a list of phone numbers from the group, presence information, and configuration options. The MT Server 44 consults with the Resource Registrar to get a conference with the appropriate number of lines. The MT Server 44 then sends a message to the MC Server 50 requesting a conference be created. The request also includes the ANI of the initiator that is stored by the MC Server 50. Simultaneously, the MT Server 44 responds to the SS7 server 42 request with information about where the incoming line should be routed. The SS7 server 42 routes the call to the appropriate bridge 30. The MC Server 50 creates the conference along with a state machine for controlling it. The MC Server 50 handles the incoming call, and checks it against the stored ANI. Based on this match, the user is automatically placed in the conference just created. At this point, a state machine for the initiator's line is created. Simultaneously, the users are added to the conference and are dialed out.

For each phone number/line to be dialed (answer only scenario): the bridge creates a state machine for the line; the phone number is translated based on calling rules for the bridge; the number is dialed; upon answering, each line is played a message ending with a request to press any key to join; and upon detecting a DTMF, the user is placed in the conference.

3. HDML or WML (“WAP”) Initiated Conference Now Initiated Trusting Presence: Initiator signs into the mobile web site. Initiator selects group and individuals from the group to include in the call. Additional direct dial numbers may also be entered. Initiator presses Conference Now button. HTTP request is sent to Web server 40 containing form information about the options that the initiator selected. This information includes the action type and the selected group's members. The Web server 40 then sends a message to the MT Server 44 to create the conference and waits for a response. The message contains the list of all users to call. The MT Server 44 receives the create conference message and handles it as appropriate. The MT Server 44 requests resources from the RR. The MT Server 44 then sends a message to the MC Server 50 requesting that a conference be created. Included in the message is a list of phone numbers to be dialed and their associated line numbers. The MC Server 50 receives the create conference message and handles it as appropriate. The conference is created. The MC Server 50 sends SUCCESS message back to the MC Server 50. The MC Server 50 then sends a SUCCESS message back to the Web server 40. Simultaneously, the MC Server 50 continues to create the conference. The MC Server 50 creates the users on the bridge 30 without dialing and then waits for a configurable amount of time. Upon receiving the incoming success message, the Web server 40 sends back a web page saying something to the effect of “Success, disconnect now so you can get called”- but preferably shorter. After the MC Server 50 delay has expired, the MC Server 50 begins to dial the phones.

For each phone number/line to be dialed (answer only scenario): the bridge creates a state machine for the line; the phone number is translated based on calling rules for the bridge; the number is dialed; upon answering, each line is played a message ending with a request to press any key to join; and, upon detecting a DTMF, the user is placed in the conference.

4. Conference Later Notification Trusting Presence: Initiator signs into the mobile web site. Initiator selects group and individuals from the group to include in the call. Additional direct dial numbers may also be entered. Initiator presses Schedule Later button. A short text message may now be entered. An HTTP request is sent to Web server 40 containing form information about the options that the initiator selected. This information comprises the action type and the selected group members. The Web server 40 then sends a message to the MT Server 44 to send notification of a conference and waits for a response. The message contains the list of all users to invite, the time and date, and a short text message. The MT Server 44 receives the message and hands it to the Notifier. The Notifier gets the email addresses for users determined to be at their desk from the database. The email addresses are preferably input by the users when they build their team lists, and are stored in the application database. Email messages are sent to those users containing date, time, and the short message. Also included for error purposes are the initiator's name and phone number and the individual's phone number. For each user that was determined to be at a mobile phone location, an SMS message is sent. The MC Server 50 sends a message to Web server 40 indicating completion of command. If there were users who were not reachable by notification (user at office w/o email, etc.), they are listed and returned to the Web server 40 with a pseudo-success message. If all users were sent notifications, then a success message is returned.

The Notifier will monitor its email account (the account from which email notifications are sent) for returned emails. For each returned email (that is not the initiator), a notification message should be sent to the initiator.

A failed email notification stores a flag in the user's group list members table. When the user logs in to his account, the list member who had a failed email notification is highlighted (as something that may need to be fixed).

5. Requested Line is In Use: MT Server 44 requests a line in response to a Conference Now request from the Web server 40, sending that request to the MC Server 50. MC Server 50 tries to use the line, but the line is in use (someone dialed in on it). MC Server 50 makes request to MT Server 44 for a new line and provides the reason.

In one embodiment, conferencing using speech recognition is enabled. A preferred embodiment comprises a speech recognition interface that utilizes a VXML gateway interface, preferably on the MC Server, to interface to a speech recognition server. The VXML scripts are dynamically generated from the information in the database in a similar fashion as the WAP pages (both are XML-based).

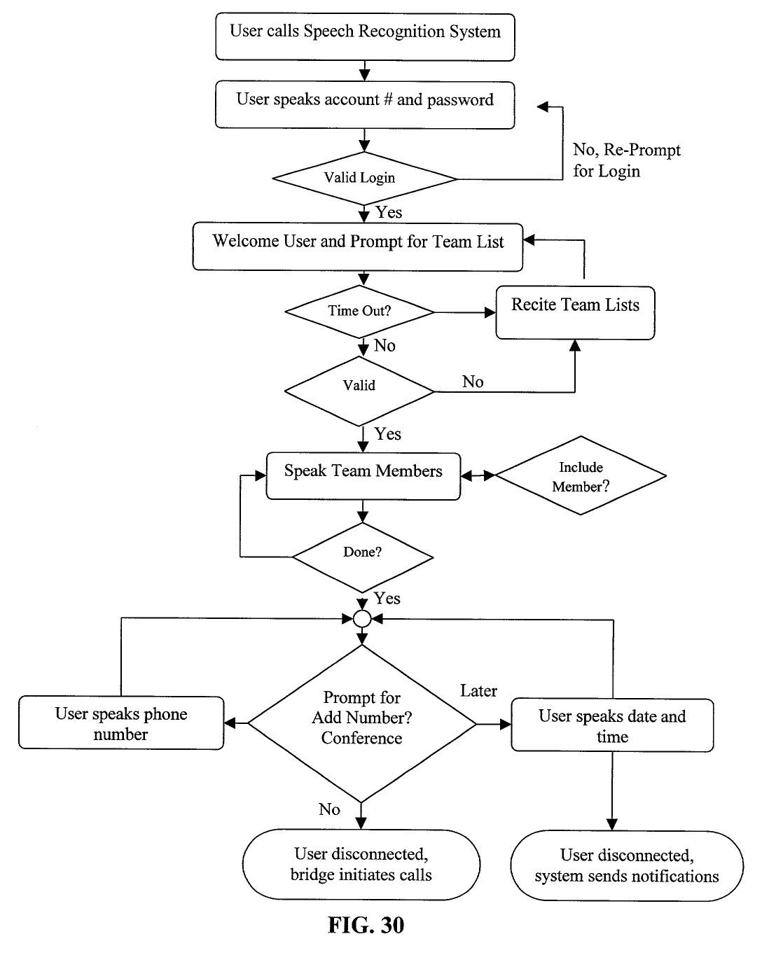

The VXML gateway points to a URL on a web server 40. Users dial into phone ports on the VXML Gateway. The VXML gateway retrieves VXML scripts and audio prompt files from the web server 40 and interprets them according to the VXML specifications. The VXML gateway can also take advantage of DNIS information, so that different phone numbers can point to different URLs on the web server 40 to allow the system to be partitioned for different services of end-users. FIG. 30 shows preferred call flow general operation with member selection.

Preferably, a caller connects to the voice portal and selects the conference option. After selecting the specific group and participants, the command is given to initiate a conference call. Once the command is given, a prompt is played to the initiator to hang-up, or the connection is hung up by the system, and the initiator is called back by the bridge along with the other conference participants.

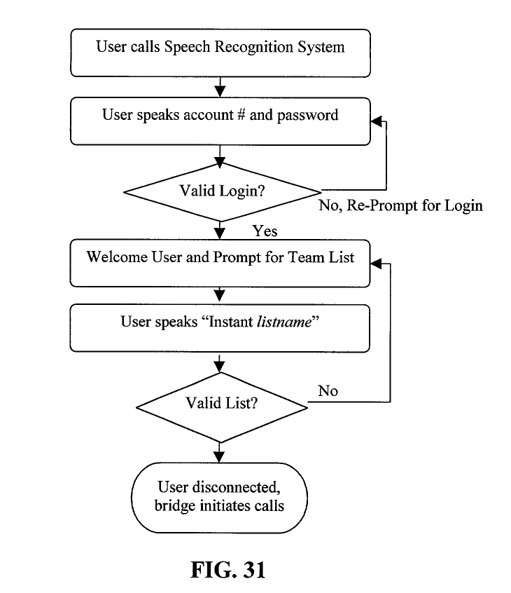

The process shown in FIG. 31 allows the conference initiator to start a conference immediately instead of being prompted for each name in the list, by simply speaking “Instant [listname].”

In an alternate embodiment, the conference initiator is not required to disconnect from the voice portal. The initiator, upon selecting a group of people to conference with, is then either transferred or linked into the conferencing bridge. If the caller is linked into the bridge, speech recognition capabilities can be maintained while the initiator is in the conference call. The link is preferably established through the voice portal and into the bridge, and the audio passes through the portal.

Although the present invention has been shown and described with respect to preferred embodiments thereof, various changes, omissions and additions to the form and detail thereof, may be made therein, without departing from the spirit and scope of the invention.

What is claimed is:

1. A system for providing reliable audio conferencing; comprising:
two or more bridge servers;
one or more conferencing servers, each of which is configured to communicate with at least one of said bridge servers; and
a transaction server, in communication with each conferencing server, wherein said transaction server is configured to manage conferencing resources among said conferencing servers.

2. The system of claim 1, further comprising one or more SS7 servers in communication with said transaction server, wherein each SS7 server is configured to receive data from wireless or wireline service providers.

3. The system of claim 1, further comprising one or more Web servers in communication with said transaction server, wherein each Web server is configured to dynamically generate wireless mark up language that can be communicated to wireless devices.

4. The system of claim 1, wherein said transaction server is configured to process incoming messages using a thread pool.

5. The system of claim 1, wherein said transaction server is configured to assign each conferencing server a list of bridge servers to control.

6. The system of claim 1, wherein said transaction server is configured to perform load balancing among the conferencing servers.

7. The system of claim 1, wherein the transaction server is configured to perform load balancing among bridge servers.

8. The system of claim 1, wherein each conferencing server is configured to command at least one bridge server to dial a list of telephone numbers.

9. The system of claim 8, wherein each conferencing server is configured to implement a DTMF interactive voice response system.

10. The system of claim 5, wherein each conferencing server is configured to monitor bridge status for each bridge assigned to it and to provide bridge status information to the transaction server.

11. The system of claim 6, wherein the transaction server and conferencing servers are configured such that bridge servers assigned to a first conferencing server are subsequently assigned to a second conferencing server by the transaction server if the first conferencing server fails.

12. The system of claim 3, wherein at least one Web server is configured to communicate over a computer network with a wireless device configured to display a graphical user interface in accordance with data received from said Web server.

13. The system of claim 12, wherein said graphic user interface enables a user to enter information to schedule a conference call for a specified future time.

14. The system of claim 13, wherein said Web server is configured to receive conference scheduling information from said wireless device.

15. A method for conferencing, comprising:
receiving a request for a conference call;
assigning a first bridge server to said conference call;
assigning a first monitoring server to monitor said bridge server;
setting up said conference call on said first bridge server; and
if said first bridge server or said first monitoring server fails, transferring said conference call to a second bridge server or a second monitoring server.

16. A method for conferencing, comprising:
receiving a telephone call from a caller;
providing an audio prompt asking the caller for information identifying one or more participants in a conference call;
receiving a voice reply from the caller in response to the audio prompt; and
setting up a conference call based on the voice reply.

17. The method of claim 16, further comprising receiving spoken date and time information for the conference call from the caller.

18. The method of claim 16, further comprising receiving spoken account number and password information from the caller.

19. Software for conferencing, comprising:
software for receiving a telephone call from a caller;
software for providing an audio prompt asking the caller for information identifying one or more participants in a conference call;
software for receiving a voice reply from the caller in response to the audio prompt; and
software for setting up a conference call based on the voice reply.

20. The software of claim 19, further comprising software for receiving spoken date and time information for the conference call from the caller.

21. The software of claim 19, further comprising software for receiving spoken account number and password information from the caller.
